(19) United States
(12) Patent Application Publication
(10) Pub. No.: US 2026/0194463 A1
(43) Pub. Date: Jul. 9, 2026

(54) SYSTEMS FOR TRIGGERING EMISSION FROM TRIPLET STATES AND METHODS OF USE THEREOF

(71) Applicant: CALICO LIFE SCIENCES LLC, South San Francisco, CA (US)

(72) Inventors: Andrew Gregory York, San Francisco, CA (US); Maria del Mar Ingaramo, San Francisco, CA (US); Julia Lazzari-Dean, Oakland, CA (US)

(21) Appl. No.: 19/128,698

(22) PCT Filed: Nov. 10, 2023
(86) PCT No.: PCT/US2023/037134

§ 371 Date: May 9, 2025

Related U.S. Application Data
(60) Provisional application No. 63/383,141, filed on Nov. 10, 2022.

(51) Int. Cl. G01N 21/64

(52) U.S. Cl. CPC G01N 21/6428; G01N 2021/6439

(57) ABSTRACT

Methods of inferring rates of rotational diffusion of a collection of fluorophores. The method includes applying a first pulse of polarized light to excite a plurality of fluorophores in the collection of fluorophores to a triplet state. Emission from the triplet state is triggered by the application of a second pulse of polarized light having a different wavelength from the first pulse of polarized light. The triggered emissions, having a third wavelength different than one or both of the first pulse of polarized light or second pulse of polarized light. The rates of diffusion of the collection of fluorophores can be inferred based on the triggered emission. Methods for inferring protein binding using triggered emission are further disclosed. Systems for measuring rotational diffusion of a collection of fluorophores using triggered emission are also disclosed.

### CROSS-REFERENCE TO RELATED APPLICATIONS

This application claims priority to U.S. Patent Application No. 63/383,141, filed Nov. 10, 2022, the entire contents of which are incorporated herein by reference in their entirety.

### BACKGROUND

Proteins in solution “tumble,” i.e., change orientation, stochastically. The rate of tumbling is approximately proportional to the mass of the protein. Thus, when a protein binds to or unbinds from some other macromolecule, its rate of tumbling changes. This means that in certain circumstances, protein binding dynamics may be inferred from accurate measurement of tumbling rates.

Fluorescent molecules, termed fluorophores, emit polarized light, with the polarization direction determined by the fluorophore orientation. Similarly, fluorophores can be excited with laser light, and the probability of excitation depends on the polarization direction of the laser light and the orientation of the fluorophore. When the polarization of the excitation beam corresponds to the fluorophore orientation, there is an efficient transfer of energy from the laser beam to the fluorophore and the fluorophore has a high probability of being excited. In contrast, when the polarization of the excitation beam is perpendicular to the fluorophore orientation, there is a very low probability that the fluorophore will be excited. Fluorescent emissions from excited fluorophores can be measured using a photosensitive detector. Accordingly, by accurately controlling which fluorophore orientations are excited, and accurately measuring the polarization of fluorescent emission, fluorophore orientation can be inferred. Further, fluorophore tumbling rates can be inferred from measuring the dynamics of the fluorophore orientation. Thus, if the fluorophores are attached to proteins of interest, protein binding dynamics can be inferred.

Excited triplet states are believed to be the starting point for many possible photochemical reactions leading to phenomena such as blinking or bleaching. It has been proposed that triplet states having millisecond lifetimes can absorb a second photon to form a higher excited triplet state which can serve as the origin for further chemical transformations and possibly explain observed long-lived, i.e., on the order of hundreds of microseconds to several milliseconds, photophysically formed intermediates for some fluorescent proteins. Proteins containing chromophores form a triplet state with a low quantum yield, e.g., about 1%, with a lifetime of a few milliseconds. In principle, with the long lifetime of the triplet state, the triplet state can be probed to cause a return to the singlet state and this emission may be able to serve as a metric for inferring changes in a collection of fluorophores, such as rates of rotational diffusion and protein binding reactions.

### SUMMARY OF INVENTION

In accordance with an aspect, there is provided a method of inferring rates of rotational diffusion of a collection of fluorophores. The method may include applying a first pulse of light at a first wavelength and first polarization to the collection of fluorophores to excite a plurality of fluorophores in the collection of fluorophores to a triplet state. The method may include applying a second pulse of light at a second wavelength and second polarization to the plurality of excited fluorophores in the triplet state to trigger polarized emission by the plurality of excited fluorophores in the triplet state, the second wavelength being different than the first wavelength. The method further may include detecting the triggered polarized emissions from the plurality of excited fluorophores in the triplet state, the triggered emissions having a third wavelength different than one or both of the first wavelength or the second wavelength. The method additionally may include inferring the rates of rotational diffusion of the collection of fluorophores based on the detected the triggered polarized emissions from the plurality of excited fluorophores in the triplet state.

In some embodiments, the second wavelength may be greater than the first wavelength. In some embodiments, the second wavelength may be less than the first wavelength. In some embodiments, the third wavelength may be greater than the second wavelength. In some embodiments, the third wavelength may be less than the second wavelength.

In some embodiments, wherein the first polarization may be in the x-direction and the second polarization may be in the y-direction. In some embodiments, the first polarization may be in the x-direction and the second polarization may be in the x-direction.

In some embodiments, a delay between the first pulse of light and second pulse of light may be within a lifetime of the plurality of excited fluorophores in the triplet state. For example, the delay between the first pulse of light and second pulse of light may be in the nanosecond (ns) range to the microsecond range, in part determined by detection of rotational diffusion in the collection of fluorophores.

In accordance with an aspect, there is provided a method of inferring protein binding. The method may include applying an excitation pulse of light at first wavelength and first polarization to a sample including proteins of interest and a collection of fluorophores to excite a plurality of fluorophores in the collection of fluorophores to a triplet state. The method may include applying a probe pulse of light at a second wavelength and second polarization to the plurality of excited fluorophores in the triplet state in the sample to trigger emission by the plurality of excited fluorophores in the triplet state in the sample. The method further may include detecting triggered polarized emissions from the plurality of excited fluorophores in the triplet state in the sample. The method further may include inferring an estimated tumbling rate of the collection of fluorophores based on the detected triggered polarized emissions from the plurality of excited fluorophores in the triplet state in the sample. The method additionally may include inferring a degree of protein binding in the sample based on the estimated tumbling rate.

In some embodiments, wherein the first polarization may be in the x-direction and the second polarization may be in the y-direction. In some embodiments, the first polarization may be in the x-direction and the second polarization may be in the x-direction.

In some embodiments, detecting the triggered polarized emissions from the plurality of excited fluorophores in the triplet state in the sample may include receiving triggered polarized emissions from the plurality of excited fluorophores in the triplet state in the sample at a photosensitive detector.

In some embodiments, a delay between the first pulse of light and second pulse of light is within a lifetime of the plurality of excited fluorophores in the triplet state.

In accordance with an aspect, there is provided a system for measuring rotation diffusion of a collection of fluorophores. The system may include a sample chamber configured to hold the collection of fluorophores. The system may include a first light source apparatus configured to produce a first pulse of light at a first wavelength and having a first polarization. The system further may include a second light source apparatus configured to produce a second pulse of light at a second wavelength and having a second polarization. The first pulse of light and the second pulse of light being may be temporally separated from one another by a predetermined time delay within the triplet state lifetime of the collection of fluorophores upon excitation by the first pulse of light. The first light source apparatus and the second light source apparatus further may be configured to direct the first pulse of light and the second pulse of light to the sample chamber. The system may include a detector configured to receive polarized emissions from the collection of fluorophores. The collection of fluorophores may emit the polarized emissions in response to being illuminated by the first pulse of light to produce a population of excited fluorophores in a triplet state. The second pulse of light may trigger emission from the population of excited fluorophores in the triplet state. The detector further may be configured to provide an output representative of the detected polarized emissions from the population of excited fluorophores in the triplet state. The system additionally may include a controller coupled to the detector and configured to receive the output from the detector and to determine an estimated rate of rotational diffusion of the collection of fluorophores based on the output received from the detector.

In further embodiments, the system may include optics disposed between the sample chamber and the detector and configured to direct the polarized emissions to the detector.

In some embodiments, the first pulse of light may be is x-polarized and the second pulse of light may be y-polarized. In some embodiments, the first pulse of light may be is x-polarized and the second pulse of light may be x-polarized.

In some embodiments, the first light source apparatus and the second light source apparatus may be lasers.

In further embodiments, the controller may be configured to display an indication of the estimated rate of rotational diffusion of the collection of fluorophores.

In some embodiments, the sample chamber may hold a compound of interest in addition to the collection of fluorophores. The compound of interest may be, but is not limited to, proteins, a nucleic acid, e.g., DNA or RNA, a lipid membrane, or any other type of molecule capable of providing useful information when associated with a fluorophore. When the compound of interest is a protein, the controller may be further configured to infer a degree of protein binding between the collection of proteins and the collection of fluorophores based in part on the estimated rate of rotational diffusion of the collection of fluorophores.

In some embodiments, the individual ones of the collection of fluorophores are bound to corresponding individual ones of a collection of carrier proteins and the sample chamber further holds a compound of interest, the controller may be further configured to infer a degree of protein binding between the collection of proteins of interest and the collection of carrier proteins based in part on the estimated rate of rotational diffusion of the collection of fluorophores.

### BRIEF DESCRIPTION OF THE DRAWINGS

Various aspects of at least one embodiment are discussed below with reference to the accompanying figures, which are not intended to be drawn to scale. The figures are included to provide illustration and a further understanding of the various aspects and embodiments and are incorporated in and constitute a part of this specification but are not intended as a definition of the limits of the invention. In the figures, each identical or nearly identical component that is illustrated in various figures is represented by a like numeral. For purposes of clarity, not every component may be labeled in every figure. In the figures:

FIG. 1 illustrates a block diagram of one embodiment of a measurement system according to aspects disclosed herein;

FIG. 2 is a flow diagram of an example of a process of inferring rates of rotational diffusion using fluorescent tags according to certain aspects disclosed herein;

FIG. 3 is a flow diagram of an example of a process of inferring protein binding using fluorescent tags according to certain aspects disclosed herein; and

FIGS. 4A-4E illustrate a model system for measuring fluorescence from triggered triplet states and simulated protein tumbling times. FIG. 4A illustrates the model pump-probe imaging system. FIGS. 4B-4E illustrate simulated fluorescence intensities in the X and Y detector channels (I_{X}, I_{Y}) and resulting polarization for tumbling times of 450 ns, 900 ns, 3000 ns, and an equal part mixture of 450 ns and 3000 ns tumbling times, representing unbound proteins, a small protein complex, and a large protein complex, respectively. FIG. 4B illustrates the simulated intensities and tumbling curves for a concentration of 2×10⁶ fluorophores and a triplet state yield of 50%. FIG. 4C illustrates the simulated intensities and tumbling curves for a concentration of 2×10⁵ fluorophores and a triplet state yield of 50%. FIG. 4D illustrates the simulated intensities and tumbling curves for a concentration of 2×10⁶ fluorophores and a triplet state yield of 1%. FIG. 4E illustrates the simulated intensities and tumbling curves for a concentration of 2×10⁵ fluorophores and a triplet state yield of 1%.

### DETAILED DESCRIPTION

Aspects and embodiments are directed to an improved method to infer protein binding in vivo, via optical measurements of the triplet state of fluorescent tags attached to these proteins, by triggering emission from the triplet state. As it pertains to this disclosure, and as noted above, long-lived excited triplet states with about a 1% quantum efficiency can be produced from typical fluorescence measurements, and due to the long lifetime of the triplet state, a transition back to the singlet state can be triggered that permits the measurement of slow physical processes such as protein tumbling.

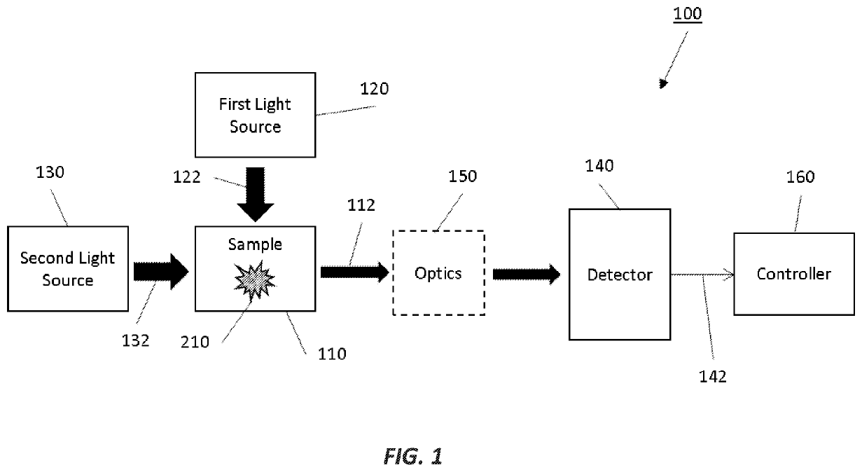

FIG. 1 is a block diagram of one non-limiting example of a system constructed and arranged to implement an analysis process using triggered emissions from a triplet state. The system 100 includes a sample chamber 110 that contains the collection of fluorophores 210 along with other compounds of interest. The compound of interest may be, but is not limited to, proteins, a nucleic acid, e.g., DNA or RNA, a lipid membrane, or any other type of molecule capable of providing useful information when associated with a fluorophore. In a non-limiting example, for a protein binding detection application, the sample chamber 110 may contain a solution that includes the proteins of interest along with the collection of fluorophores, which may be bound to carrier proteins. The sample chamber may be an artificial chamber or a biological structure, such as one or more cells. The system 100 includes a first light source apparatus 120 that is configured to produce and apply a first pulse of light 122 at a first wavelength and having a first polarization to the sample chamber 110. In one example, first light source apparatus 120 is a laser; however, other light sources capable of producing polarized light pulses may be used. The system 100 further includes a second light source apparatus 130 that is configured to produce and apply a second pulse of light 132 at a second wavelength and having a second polarization to the sample chamber 110. The first pulse of light 122 and the second pulse of light are temporally separated from one another by a predetermined time delay within the triplet lifetime of the collection of fluorophores upon excitation by the first pulse of light 122. The predetermined time delay may be, in part, determined by detection of rotational diffusion in the collection of fluorophores in the sample chamber 110.

In some embodiments, the predetermined time delay may be from about 1 ns to about 1000 ns, e.g., about 1 ns to about 100 ns, about 10 ns to about 200 ns, about 20 ns to about 300 ns, about 30 ns to about 400 ns, about 40 ns to about 500 ns, about 50 ns to about 600 ns, about 60 ns to about 700 ns, about 70 ns to about 800 ns, about 80 ns to about 900 ns, or about 100 to about 1000 ns, e.g., about 1 ns, about 2 ns, about 3 ns, about 4 ns, about 5 ns, about 6 ns, about 7 ns, about 8 ns, about 9 ns, about 10 ns, about 20 ns, about 30 ns, about 40 ns, about 50 ns, about 60 ns, about 70 ns, about 80 ns, about 90 ns, about 100 ns, about 110 ns, about 120 ns, about 130 ns, about 140 ns, about 150 ns, about 160 ns, about 170 ns, about 180 ns, about 190 ns, about 200 ns, about 210 ns, about 220 ns, about 230 ns, about 240 ns, about 250 ns, about 260 ns, about 270 ns, about 280 ns, about 290 ns, about 300 ns, about 310 ns, about 320 ns, about 330 ns, about 340 ns, about 350 ns, about 360 ns, about 370 ns, about 380 ns, about 390 ns, about 400 ns, about 410 ns, about 420 ns, about 430 ns, about 440 ns, about 450 ns, about 460 ns, about 470 ns, about 480 ns, about 490 ns, about 500 ns, about 510 ns, about 520 ns, about 530 ns, about 540 ns, about 550 ns, about 560 ns, about 570 ns, about 580 ns, about 590 ns, about 600 ns, about 610 ns, about 620 ns, about 630 ns, about 640 ns, about 650 ns, about 660 ns, about 670 ns, about 680 ns, about 690 ns, about 700 ns, about 710 ns, about 720 ns, about 730 ns, about 740 ns, about 750 ns, about 760 ns, about 770 ns, about 780 ns, about 790 ns, about 800 ns, about 810 ns, about 820 ns, about 830 ns, about 840 ns, about 850 ns, about 860 ns, about 870 ns, about 880 ns, about 890 ns, about 900 ns, about 910 ns, about 920 ns, about 930 ns, about 940 ns, about 950 ns, about 960 ns, about 970 ns, about 980 ns, about 990 ns, or about 1000 ns, i.e., 1 μs.

In some embodiments, the predetermined time delay may be from about 1 μs to about 1000 μs, e.g., about 1 μs to about 100 μs, about 10 μs to about 200 μs, about 20 μs to about 300 μs, about 30 μs to about 400 μs, about 40 μs to about 500 μs, about 50 μs to about 600 μs, about 60 μs to about 700 μs, about 70 μs to about 800 μs, about 80 μs to about 900 μs, or about 100 to about 1000 μs, e.g., about 1 μs, about 2 μs, about 3 μs, about 4 μs, about 5 μs, about 6 μs, about 7 μs, about 8 μs, about 9 μs, about 10 μs, about 20 μs, about 30 μs, about 40 μs, about 50 μs, about 60 μs, about 70 μs, about 80 μs, about 90 μs, about 100 μs, about 110 μs, about 120 μs, about 130 μs, about 140 μs, about 150 μs, about 160 μs, about 170 μs, about 180 μs, about 190 μs, about 200 μs, about 210 μs, about 220 μs, about 230 μs, about 240 μs, about 250 μs, about 260 μs, about 270 μs, about 280 μs, about 290 μs, about 300 μs, about 310 μs, about 320 μs, about 330 μs, about 340 μs, about 350 μs, about 360 μs, about 370 μs, about 380 μs, about 390 μs, about 400 μs, about 410 μs, about 420 μs, about 430 μs, about 440 μs, about 450 μs, about 460 μs, about 470 μs, about 480 μs, about 490 μs, about 500 μs, about 510 μs, about 520 μs, about 530 μs, about 540 μs, about 550 μs, about 560 μs, about 570 μs, about 580 μs, about 590 μs, about 600 μs, about 610 μs, about 620 μs, about 630 μs, about 640 μs, about 650 μs, about 660 μs, about 670 μs, about 680 μs, about 690 μs, about 700 μs, about 710 μs, about 720 μs, about 730 μs, about 740 μs, about 750 μs, about 760 μs, about 770 μs, about 780 μs, about 790 μs, about 800 μs, about 810 μs, about 820 μs, about 830 μs, about 840 μs, about 850 μs, about 860 μs, about 870 μs, about 880 μs, about 890 μs, about 900 μs, about 910 μs, about 920 μs, about 930 μs, about 940 μs, about 950 μs, about 960 μs, about 970 μs, about 980 μs, about 990 μs, or about 1000 μs, i.e., 1 ms.

With continued reference to FIG. 1, the second light source apparatus 130 is configured to produce the second pulse of light 132 having a polarization that is either orthogonal or parallel to that of the first pulse of light 122 from the first light source apparatus 120. In a non-limiting example, the first pulse of light is x-polarized and the second pulse of light is y-polarized. In another non-limiting example, the first pulse of light is x-polarized and the second pulse of light is x-polarized. In one example, the second light source apparatus 130 is a laser; however, other light sources capable of producing polarized light pulses may be used. In FIG. 1, the first light source apparatus 120 and the second light source apparatus 130 are shown as separate devices; however, in other examples a single light source capable of producing parallel or orthogonally polarized light pulses different wavelengths may be used. For example, a laser with a configurable polarizer may be used. In another example, a laser equipped with an optical parametric oscillator and/or an optical parametric amplifier to provide for variable wavelengths may be used. This disclosure is in no way limited by the type of light source apparatus for one or both of the first light source apparatus 120 and the second light source apparatus 130. Further, in FIG. 1, the first light source apparatus 120 and the second light source apparatus 130 are schematically shown on different sides of the sample chamber 110; however, this is for ease of illustration only; in practical implementations, the first light source apparatus 120 and the second light source apparatus 130 may be disposed in any arrangement relative to the sample chamber 110 and each other.

Responsive to application of the first pulse of light 122 and the second pulse of light 132 to the collection of fluorophores 210 in the sample chamber 110, the fluorophores produce the polarized emissions 112 as disclosed herein. These emissions 112, including a population of excited fluorophores in a triplet state from the first pulse of light 122 and triggered emission after the predetermined time delay from the population of excited fluorophores in the triplet state from the second pulse of light 132, are detected by a detector 140. The detector 140 may include one or more photodetectors and associated electronic read-out circuitry that provides an electrical signal representative of the detected polarized emissions 112. The system 100 may optionally include optics 150 configured to relay the polarized triggered emissions 112 to the detector 140. The optics 150 may include one or more mirrors, lenses, or combination thereof, and optionally one or more filters, polarizers, beamsplitters, or other optical components configured to provide the polarized triggered emissions 112 to the detector 140. The output 142 from the detector 140 is provided to a controller 160. The output 142 may be an analog or digital signal, for example, representative of the polarized emissions detected by the detector 140. The controller 160 may include circuitry, optionally including a processor or other computing components, configured to analyze or otherwise manipulate the output 142 from the detector 140 to implement the application for which the system 100 is utilized. For example, the controller 160 may be configured to produce one or more plots of the collected data that an end user may use to infer a tumbling rate of the fluorophores. In another non-limiting example, the controller 160 may be configured to produce data corresponding to such a curve or set of curves and to analyze the data to produce an output indicative of an inferred tumbling rate. In another example, the controller 160 may be further configured to analyze the data to calculate an estimated tumbling rate and based on stored information (such as the correlation between tumbling rates and molecule mass, known properties of the collection of fluorophores 210, and known properties of one or more compounds of interest) and the estimated tumbling rate, produce an output indicative of a degree of protein binding if a protein is a compound of interest. Given the benefit of this disclosure, those skilled in the art will appreciate that many variations of the above examples may be implemented and that various embodiments of the system 100 can be configured for a variety of different applications based on the principles and techniques disclosed herein.

In some embodiments of the disclosed system, the compound of interest includes one or more of a protein, a nucleic acid, a lipid membrane, or any other type of molecule capable of providing useful information when associated with a fluorophore. Proteins are an exemplary use of the disclosed system, and when the compound of interest is a collection of proteins, the controller 160 is further configured to infer a degree of protein binding between the collection of proteins and the collection of fluorophores based in part on the estimated rate of rotational diffusion of the collection of fluorophores.

In some embodiments of the disclosed system, the individual ones of the collection of fluorophores are bound to corresponding individual ones of a collection of carrier proteins and the sample chamber 110 further holds a collection of proteins of interest. In this configuration, the controller 160 is further configured to infer a degree of protein binding between the collection of proteins of interest and the collection of carrier proteins based in part on the estimated rate of rotational diffusion of the collection of fluorophores.

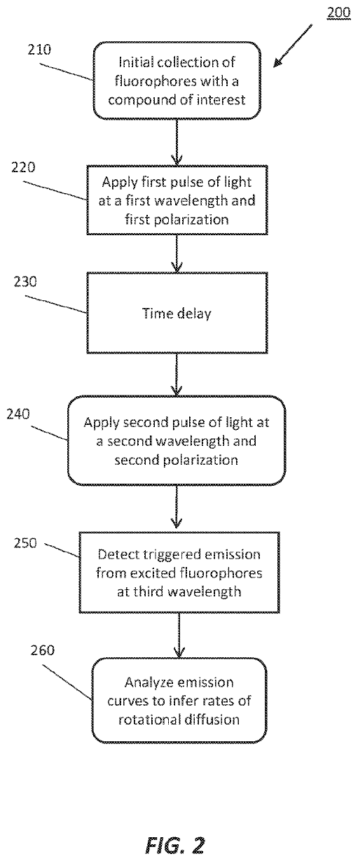

FIG. 2 illustrates a flow diagram of one non-limiting example of a process of inferring rates of rotation diffusion using triggered emission from triplet state fluorophores according to certain embodiments. The process 200 begins at step 210 with an initial collection of fluorophores 210 which may be associated with a compound of interest, such as a protein or nucleic acid. In step 220, a first pulse of light at a first wavelength and first polarization is applied to the collection of fluorophores to excite a plurality of fluorophores in the collection of fluorophores to a triplet state. As disclosed herein, this process has a quantum yield of about 1% for typical fluorophores. Following application of the first pulse of light to produce a population of triplet state fluorophores that are long lived, there is a predetermined time delay at step 230 to permit observation of rotation diffusion. The predetermined time delay, as disclosed herein, is on the order from ns to μs. Following the predetermined time delay, with the predetermined time delay being within the triplet state lifetime of the plurality of fluorophores in the triplet state, a second pulse of light at a second wavelength and second polarization is applied to the plurality of excited fluorophores in the triplet state to trigger polarized emission by the plurality of excited fluorophores in the triplet state in step 240. The second wavelength is generally different than the first wavelength, and depending on the fluorophore, may be of a greater wavelength or a lower wavelength. In some embodiments, the first polarization can be in the x-direction and the second polarization can be in the y-direction. In other embodiments, the first polarization can be in the x-direction and the second polarization can be in the x-direction.

With continued reference to FIG. 2, the second pulse of light directed into the collection of triplet state fluorophores results in the emission of a photon at a third wavelength that is different than one or both of the first wavelength or the second wavelength. The polarized triggered emissions at the third wavelength are detected by a suitable detector at step 250 and yield a collection of triggered emission curves. These triggered emission curves can be analyzed to infer rates of rotation diffusion (step 260). As a non-limiting example, if the fluorophore is associated with green fluorescent protein (GFP), GFP exhibits fluorescence upon irradiation with 488 nm, i.e., cyan, light and this wavelength is used at the first pulse of light. The triplet state of GFP has an absorption maximum at 900 nm and this wavelength can be used as the second wavelength to probe the triplet state. Upon absorption of 900 nm photons, the resulting transition from the triplet state back to the singlet state emits a photon at about 520 nm, i.e., cyan-green light. It is noted that the aforementioned example of using GFP is only an example, and this disclosure is in no way limited by the system used to explore the triplet state and its utility for spectroscopically inferring rates of rotation diffusion, rates of tumbling, and if appropriate, protein binding.

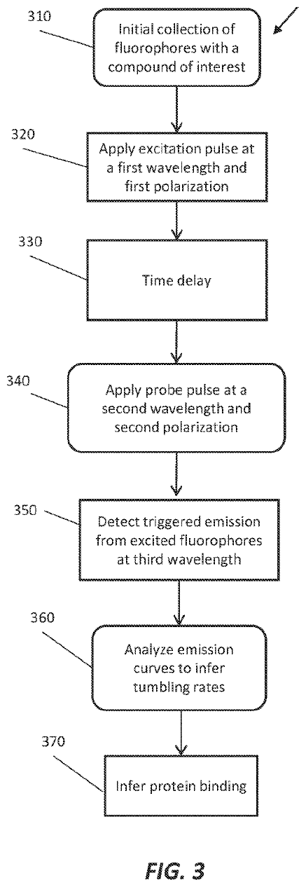

FIG. 3 illustrates a flow diagram of one example of a process of inferring protein binding using triggered emission from triplet state fluorophores according to certain embodiments. The process 300 begins at step 310 with an initial collection of fluorophores 310 and a protein of interest in a sample. In step 320, an excitation pulse at a first wavelength and first polarization is applied to the collection of fluorophores to excite a plurality of fluorophores in the collection of fluorophores to a triplet state. As disclosed herein, this process has a quantum yield of about 1% for typical fluorophores. Following application of the excitation pulse to produce a population of triplet state fluorophores that are long lived, there may be a predetermined time delay at step 330. The predetermined time delay, as disclosed herein, is on the order from ns to μs. Following the predetermined time delay, with the predetermined time delay being within the triplet state lifetime of the plurality of fluorophores in the triplet state, a probe pulse at a second wavelength and second polarization is applied to the plurality of excited fluorophores in the triplet state to trigger polarized emission by the plurality of excited fluorophores in the triplet state in step 340. The second wavelength is generally different than the first wavelength, and depending on the fluorophore, may be of a greater wavelength or a lower wavelength. In some embodiments, the first polarization can be in the x-direction and the second polarization can be in the y-direction. In other embodiments, the first polarization can be in the x-direction and the second polarization can be in the x-direction.

With continued reference to FIG. 3, the second pulse of light directed into the collection of triplet state fluorophores results in the emission of a photon at a third wavelength that is different than one or both of the first wavelength or the second wavelength. The polarized triggered emissions at the third wavelength are detected by a suitable detector at step 350 and yield a collection of triggered emission curves. These triggered emission curves can be analyzed to infer rates of tumbling rates (step 360). By analyzing the emission curves to infer tumbling rates and based on a known relationship between tumbling rate and molecular mass, the molecule mass can be inferred, which in turn allows one to infer conditions, such as protein binding, for example (step 370) based on known estimates of the mass of the fluorescent tag (optionally in combination with a carrier protein) with and without a bound protein of interest.

### EXAMPLES

### Example 1—Pump-Probe Measurements With Triggered Emitters

To study spatially heterogeneous samples such as cells and biological tissues, mapping protein-protein interactions across the entire sample is desirable. For live samples, one goal of this type of mapping is to reveal the temporal dynamics of protein-protein interactions. State-of-the-art lightsheet microscopes can be used measure fluorescence intensity in 3D at video capture rates but cannot readily discern information related to protein tumbling.

One important component of fast imaging systems is camera-based detection, where a signal from a 2D plane is recorded in parallel. A standard scientific camera can acquire an image on millisecond timescales, but protein tumbling involves nanosecond-or microsecond-scale dynamics. To access these shorter timescales, fluorescence anisotropy is typically recorded with a single pixel detector that counts individual photons with sub-nanosecond time resolution. The collected images are then formed slowly by raster scanning a point through the sample.

Parallelized, multipixel versions of these sub-nanosecond time resolution single pixel detectors are in development but the photon count rates support by such detectors are orders of magnitude lower than modern camera sensors.

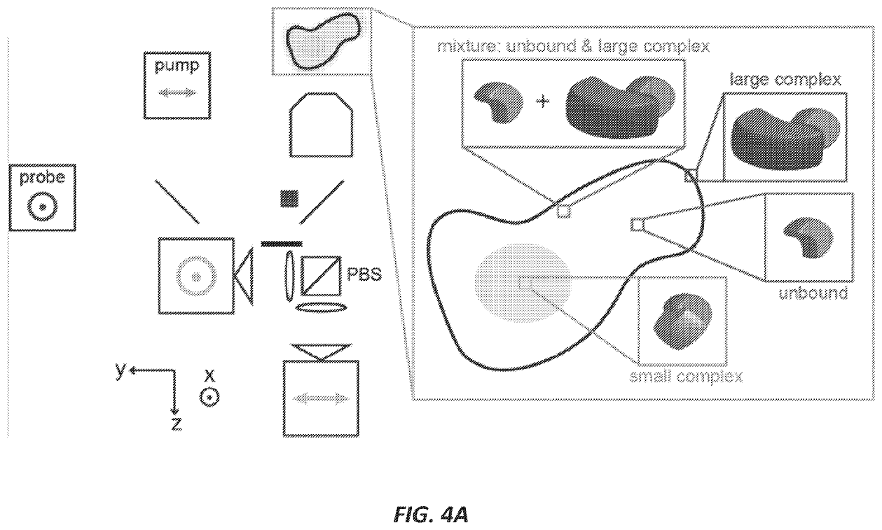

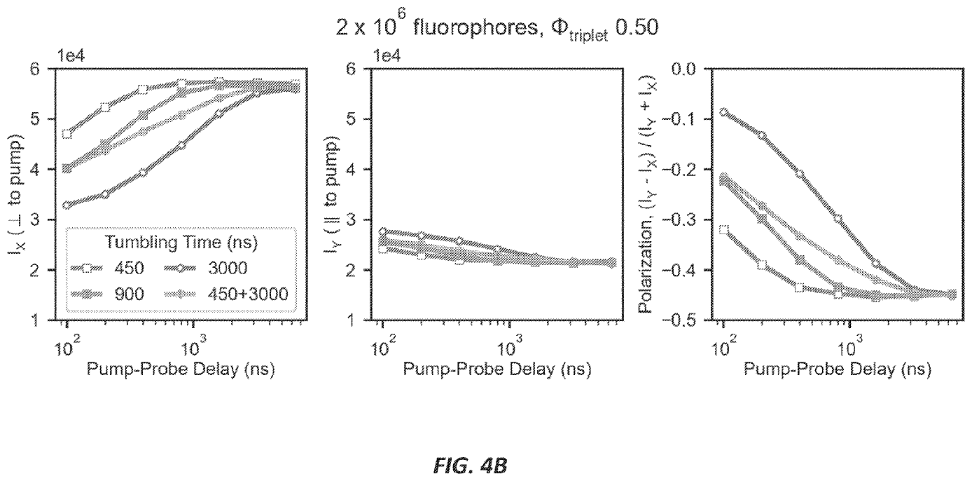

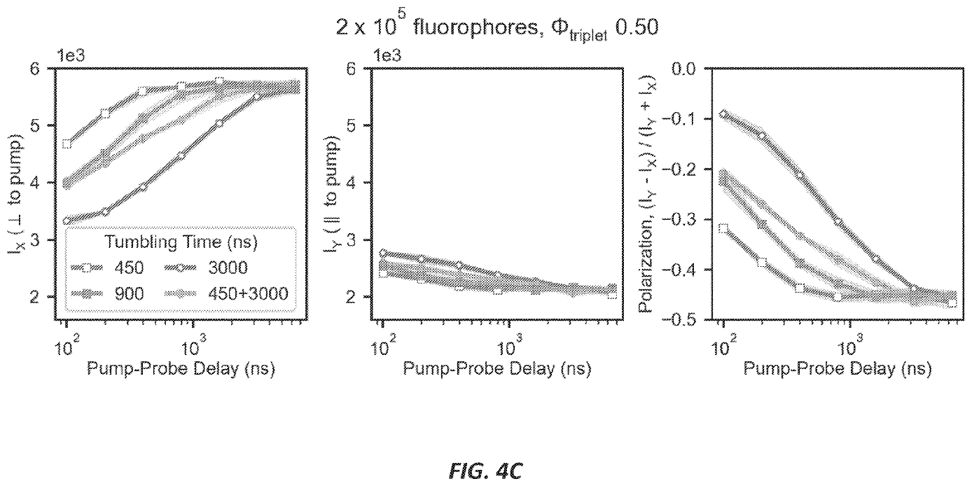

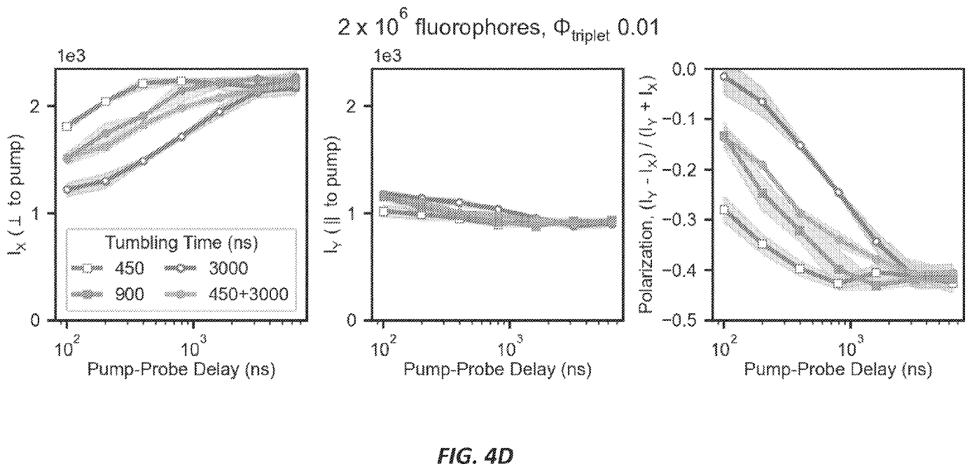

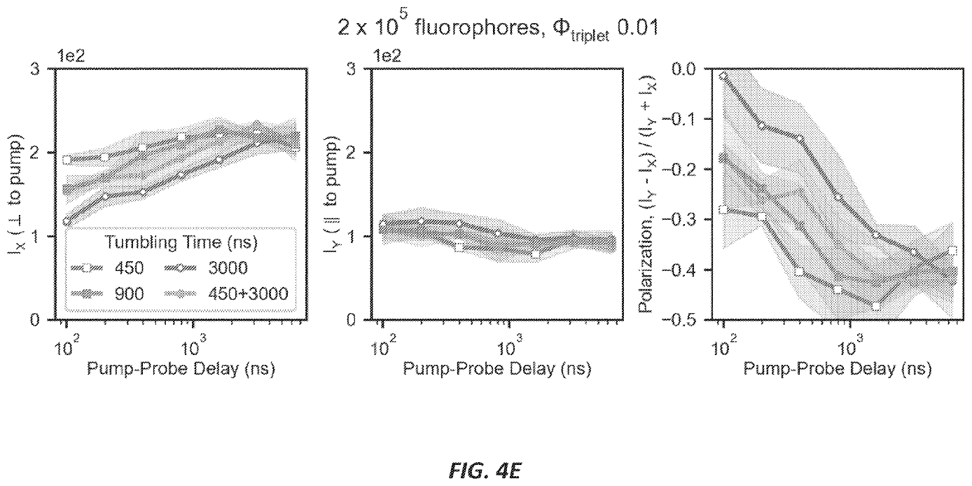

With current camera technology, a “pump-probe” imaging scheme could allow imaging an entire field of view simultaneously. Time resolution can be encoded by a variable delay between the pump and probe laser pulses. In this configuration, each camera exposure can record a single delay. A simulated experiment modeling the effects of the delay between the pump and probe laser pulses is illustrated in FIGS. 4A-4E. In FIG. 4A, illustrating a schematic a pump-probe imaging setup, the pump laser produces a pump pulse that generates fluorescence in the sample. Some of these fluorescent molecules in the sample convert to the triplet state, which after a variable delay, are triggered to fluoresce by a probe laser producing a probe pulse. Triplet states are advantageous for triggering measurements since unlike other species used for fluorescence spectroscopy that have slow switching speeds, triplet states do not have microsecond-scale dead time following the pumping, thus allowing access to nanosecond timescales. A fast shutter separates signal from the pump pulse and probe pulse. A polarizing beamsplitter, labeled as PBS in FIG. 4A, followed by two cameras records the polarized fluorescence at all points in the image. A sequence of delays is captured by successive images. As illustrated in the inset of FIG. 4A, shows how measured tumbling times could correspond to spatially compartmentalized binding events within or at the periphery of a cell. The seven delays simulated in this model experiment yielded strong prediction of intermediate delays; this result suggested that a modest number of delays would be sufficient to capture tumbling dynamics. It is believed that this modeling approach would be compatible with both widefield and lightsheet microscopes.

With respect to fluorophores, long-lived triplet states can be triggered to emit by a probe beam. “Triggered triplets,” also known as optically activated delayed fluorescence, refers to millisecond-lived triplet states that can emit prompt fluorescence when excited with far-red light. Triplet states can be generated from an excited singlet state, leading to a pulse scheme where a pump pulse at a standard absorption wavelength, e.g. 488 nm for fluorescein, can be followed by a far-red probe pulse, to trigger fluorescence. Triggered triplet signals have been experimentally shown to be compatible with tumbling measurements.

A linearly polarized pump pulse and an orthogonally polarized probe (trigger) pulse as illustrated in FIG. 4A was simulated by modeling two gated standard cameras record fluorescence following a polarizing beamsplitter. In the model, the pump beam generates triplets that are partially aligned with its polarization and therefore partially anti-aligned with the probe beam's polarization. The pump beam polarization was chosen as the reference direction. As scrambling occurs and the partial alignment with the pump polarization is lost, the emission polarization becomes more negative, i.e., orthogonal to the pump beam polarization. A fully scrambled population will give a polarization of −0.5, although saturation in the probe beam can reduce the magnitude of the polarization.

Using this pulse scheme, a sample of labeled protein with three binding states: unbound, bound to a small partner, or bound to a large partner was simulated, with the results illustrated in FIGS. 4B-4E. These results in FIGS. 4B-4E show distinguishable tumbling curves for all three binding states. The tumbling curve of a mixture of the unbound and large states is also distinguishable from that of a binding partner of intermediate mass; this type of mixtures will be present in real protein samples.

The quantum yield of triplet generation in existing fluorescent proteins is ≈1%; once the triplet state is triggered, a triplet emits at most one photon. To obtain low-variance tumbling curves, 50% triplet quantum yield and/or 105-106 molecules were simulated along with more realistic conditions of 1% triplet quantum yield. In a real sample, the number of molecules available will be constrained by the expression level of the target protein. A cell contains ≈10⁶ total proteins per cubic micron. For protein targets other than the most abundant, there is unlikely to be more than ≈10³ fluorophores per cubic micron. Therefore, for many proteins of interest, photon production will be limited. To reduce the dependence on photon count, triplet state images can be binned either in space or in time by accumulating successive pump-probe cycles to obtain sufficient signal to resolve binding states. FIGS. 4B-4E illustrate the effects of triplet quantum yield and number of molecules.

Having described above several aspects of at least one embodiment, it is to be appreciated various alterations, modifications, and improvements will readily occur to those skilled in the art. Such alterations, modifications, and improvements are intended to be part of this disclosure and are intended to be within the scope of the invention. Accordingly, it is to be appreciated that embodiments of the methods and apparatuses discussed herein are not limited in application to the details of construction and the arrangement of components set forth in the foregoing description or illustrated in the accompanying drawings. The methods and apparatuses are capable of implementation in other embodiments and of being practiced or of being carried out in various ways. Examples of specific implementations are provided herein for illustrative purposes only and are not intended to be limiting. Also, the phraseology and terminology used herein is for the purpose of description and should not be regarded as limiting. The use herein of “including,” “comprising,” “having,” “containing,” “involving,” and variations thereof is meant to encompass the items listed thereafter and equivalents thereof as well as additional items.

References to “or” may be construed as inclusive so that any terms described using “or” may indicate any of a single, more than one, and all of the described terms. Any references to front and back, left and right, top and bottom, upper and lower, and vertical and horizontal are intended for convenience of description, not to limit the present systems and methods or their components to any one positional or spatial orientation. Accordingly, the foregoing description and drawings are by way of example only, and the scope of the invention should be determined from proper construction of the appended claims, and their equivalents.

What is claimed is:

1. A method of inferring rates of rotational diffusion of a collection of fluorophores, the method comprising:
applying a first pulse of light at a first wavelength and first polarization to the collection of fluorophores to excite a plurality of fluorophores in the collection of fluorophores to a triplet state;
applying a second pulse of light at a second wavelength and second polarization to the plurality of excited fluorophores in the triplet state to trigger polarized emission by the plurality of excited fluorophores in the triplet state, the second wavelength being different than the first wavelength;
detecting the triggered polarized emissions from the plurality of excited fluorophores in the triplet state, the triggered emissions having a third wavelength different than one or both of the first wavelength or the second wavelength; and
inferring the rates of rotational diffusion of the collection of fluorophores based on the detected the triggered polarized emissions from the plurality of excited fluorophores in the triplet state.

2. The method of claim 1, wherein the second wavelength is greater than the first wavelength.

3. The method of claim 1, wherein the second wavelength is less than the first wavelength.

4. The method of claim 1, wherein the third wavelength is greater than the second wavelength.

5. The method of claim 1, wherein the third wavelength is less than the second wavelength.

6. The method of claim 1, wherein the first polarization is in the x-direction and the second polarization is in the y-direction.

7. The method of claim 1, wherein the first polarization is in the x-direction and the second polarization is in the x-direction.

8. The method of claim 1, wherein a delay between the first pulse of light and second pulse of light is within a lifetime of the plurality of excited fluorophores in the triplet state.

9. A method of inferring protein binding comprising:
applying an excitation pulse of light at first wavelength and first polarization to a sample including proteins of interest and a collection of fluorophores to excite a plurality of fluorophores in the collection of fluorophores to a triplet state;
applying a probe pulse of light at a second wavelength and second polarization to the plurality of excited fluorophores in the triplet state in the sample to trigger emission by the plurality of excited fluorophores in the triplet state in the sample,
detecting triggered polarized emissions from the plurality of excited fluorophores in the triplet state in the sample;
inferring an estimated tumbling rate of the collection of fluorophores based on the detected triggered polarized emissions from the plurality of excited fluorophores in the triplet state in the sample; and
based on the estimated tumbling rate, inferring a degree of protein binding in the sample.

10. The method of claim 9, wherein the first polarization is in the x-direction and the second polarization is in the y-direction.

11. The method of claim 9, wherein the first polarization is in the x-direction and the second polarization is in the x-direction.

12. The method of claim 9, wherein detecting the triggered polarized emissions from the plurality of excited fluorophores in the triplet state in the sample includes receiving triggered polarized emissions from the plurality of excited fluorophores in the triplet state in the sample at a photosensitive detector.

13. The method of claim 9, wherein a delay between the first pulse of light and second pulse of light is within a lifetime of the plurality of excited fluorophores in the triplet state.

14. A system for measuring rotational diffusion of a collection of fluorophores, the system comprising:
a sample chamber configured to hold the collection of fluorophores;
a first light source apparatus configured to produce a first pulse of light at a first wavelength and having a first polarization;
a second light source apparatus configured to produce a second pulse of light at a second wavelength and having a second polarization; the first and second pulses of light being temporally separated from one another by a predetermined time delay within the triplet lifetime of the collection of fluorophores upon excitation by the first pulse of light, the first light source apparatus and second light source apparatus being further configured to direct the first pulse of light and the second pulse of light to the sample chamber;
a detector configured to receive polarized emissions from the collection of fluorophores, the collection of fluorophores emitting the polarized emissions in response to being illuminated by the first pulse of light to produce a population of excited fluorophores in a triplet state and the second pulse of light to trigger emission from the population of excited fluorophores in the triplet state, the detector being further configured to provide an output representative of the detected polarized emissions from the population of excited fluorophores in the triplet state; and
a controller coupled to the detector and configured to receive the output from the detector and to determine an estimated rate of rotational diffusion of the collection of fluorophores based on the output received from the detector.

15. The system of claim 14, further comprising optics disposed between the sample chamber and the detector and configured to direct the polarized emissions to the detector.

16. The system of claim 14, wherein the first pulse of light is x-polarized and the second pulse of light is y-polarized.

17. The system of claim 14, wherein the first pulse of light is x-polarized and the second pulse of light is x-polarized.

18. The system of claim 14, wherein the first light source apparatus and the second light source apparatus comprise lasers.

19. The system of claim 14, wherein the controller is further configured to display an indication of the estimated rate of rotational diffusion of the collection of fluorophores.

20. The system of claim 14, wherein the sample chamber holds a compound of interest in addition to the collection of fluorophores.

21. The system of claim 20, wherein the compound of interest includes one or more of a protein, a nucleic acid, a lipid membrane, or any other type of molecule capable of providing useful information when associated with a fluorophore.

22. The system of claim 21, wherein when the compound of interest is a collection of proteins, the controller is further configured to infer a degree of protein binding between the collection of proteins and the collection of fluorophores based in part on the estimated rate of rotational diffusion of the collection of fluorophores.

23. The system of claim 14, wherein the individual ones of the collection of fluorophores are bound to corresponding individual ones of a collection of carrier proteins, wherein the sample chamber further holds a collection of proteins of interest, and wherein the controller is further configured to infer a degree of protein binding between the collection of proteins of interest and the collection of carrier proteins based in part on the estimated rate of rotational diffusion of the collection of fluorophores.
